(19) United States
(12) Patent Application Publication
(10) Pub. No.: US 2024/0419978 A1
(43) Pub. Date: Dec. 19, 2024

(54) MODEL EVALUATION METRICS AND EFFECTIVE MODEL SELECTION

(71) Applicant: THE TORONTO-DOMINION BANK, TORONTO (CA)

(72) Inventors: George Frazer Stein, Port Coquitlam (CA); Jesse Cole Cresswell, TORONTO (CA); Rasa Hosseinzadeh, TORONTO (CA); Yi Sui, Newmarket (CA); Brendan Leigh Ross, TORONTO (CA); Valentin Victor Villecroze, TORONTO (CA); Zhaoyan Liu, TORONTO (CA); Anthony Lawrence Caterini, TORONTO (CA); Joseph Eric Timothy Taylor, TORONTO (CA); Gabriel Loaiza Ganem, TORONTO (CA)

(21) Appl. No.: 18/738,557

(22) Filed: Jun. 10, 2024

Related U.S. Application Data
(60) Provisional application No. 63/521,581, filed on Jun. 16, 2023.

(51) Int. Cl. G06N 3/09; G06V 10/774

(52) U.S. Cl. CPC G06N 3/09; G06V 10/774

(57) ABSTRACT

A variety of generative models are trained that are trained on a reference data set. The generative models are evaluated by candidate metrics to determine the relative rankings of the models as evaluated by the different candidate metrics. Rankings as generated by the models is compared with human evaluation of the generated results as simulated and the candidate metrics that most align with the human evaluation may then be used to automatically evaluate subsequent generative models. The candidate metrics may include various types of encoding models trained for non-generative purposes, such that the selected candidate metric may represent selecting an encoding model that performs well on the generative data.

### CROSS-REFERENCE TO RELATED APPLICATIONS

This disclosure claims the benefit of U.S. Provisional Application No. 63/521,581, filed Jun. 16, 2023, the contents of which are hereby incorporated in its entirety.

### BACKGROUND

This disclosure relates generally to evaluating generative models and more particularly to determining effective automated metrics for evaluating and selecting generative models.

The capability of modern generative models to synthesize fake images that are seemingly indistinguishable from real samples has resulted in much public interest. While various metrics have been used to evaluate the quality of these models and the extent to which the productions are realistic, the unprecedented fidelity of modern synthetic images raises the question of whether the current metrics are sufficiently effective to measure the extent to which these models have truly learned to mimic real data samples. In addition, using ineffective metrics may encourage models to optimize for metrics that are not consistent with real data sets, despite that the metrics may suggest high performance by these models.

Evaluating a single generated image is straightforward, since humans can act as the “ground truth” for determining realism. Evaluating the quality of a model as a whole is much more difficult. Beyond quantifying to what extent generated data samples resemble real data from the training data set (fidelity), models may also be evaluated for how well the generated samples span the full training distribution (diversity), and whether they are truly novel or are simply reproductions of the training set (memorization). An ideal generative model will synthesize a set of high fidelity and diverse samples without memorizing the training set. Researchers are well-practiced in ranking generative models by metrics such as the Fréchet Inception Distance (FID), Inception Score (IS), and many others, which group fidelity and diversity into a single value without a clear tradeoff. Other diagnostic metrics separating sample quality from diversity, such as Precision/Recall and Density/Coverage, are also popular. However, relating such metrics to human evaluation of image quality is not straightforward. Worse, metrics are often proposed and adopted without rigorous evaluation of the real-world comparison with human interpretation of the metrics' results. This can result in the adoption and use of ineffective metrics that do not improve model performance when viewed by human evaluators.

As one example for evaluating generative models that generate images, the metric FID has become a popular metric for evaluating model quality and is often assumed to provide an effective representation space for measuring model quality. FID uses the Inception-V3 network (trained as a classifier on ImageNet data) as an encoder. However, this encoder tends to be agnostic to features unrelated to the 1 k classes of ImageNet. Further, ImageNet classifiers in general tend to be biased towards texture over shape. As a result, this popular metric may fail to generalize when applied more broadly to other types of data and can lead to evaluation of model quality that differs from human evaluation. Identifying effective metrics can be particularly difficult because the underlying encoders may themselves have architectures or training data that introduce biases and other artifacts that may prevent more general application.

### SUMMARY

To evaluate model metrics more effectively for generative models (e.g., for images, text, video, etc.), various candidate metrics are evaluated against human evaluations of generated model data. Various model architectures and configurations are trained (or pre-trained models retrieved) on a reference data set, such that the set of models being evaluated is trained to generate samples that are intended to resemble the same reference data set. Next, the resulting generated data samples are evaluated according to various candidate metrics to determine the comparative performance of the different models according to the different candidate metrics. For example, the comparative performance may indicate the respective ranking of each model according to the candidate metric.

The candidate metrics typically have a two-step design: first by extracting a lower-dimensional representation of each data sample, then scoring (e.g., calculate a notion of distance) between true and generated samples in this space. The goal of the representation extractor, or encoder, is to embed images into a representation space that has a generalized perceptual relevance across the span of natural images. The encoder may thus itself be a trained computer model that generates the representation in the representation space. The encoders may include trained models with supervised training processes (e.g., classifiers that may include selected or curated features) or self-supervised model training processes (e.g., encoders used with autoencoder structures) that can generate data sample representations.

To evaluate the effectiveness of the candidate metrics, humans may also evaluate the generated data sets and evaluate whether the data samples are realistic. That is, the humans may evaluate whether the resulting images “belong” in a data set of real images. In some embodiments, the human evaluations may determine whether given data samples are real or generated and be presented random samples from generated data sets or a reference data set (e.g., the data set on which the generative models were trained). The human evaluation of the generated data samples may then be converted to comparative evaluation of the generative models, for example, by determining the frequency that humans misclassified data samples that were generated by a particular generative model. This results in a comparative performance of the generative models according to human evaluations.

The comparative model performance according to the candidate metrics may then be compared with the human-generated comparative model performance, enabling effective evaluation of the candidate metrics according to the consistency with human evaluators. In some embodiments, this may be repeated with a plurality of different models trained on different reference data sets, such that the metrics generate rankings for a plurality of model types applied to a variety of types of data sets. A candidate metric that most-similarly evaluates the generative models compared to the human evaluators may be selected as the automatic candidate metric used to evaluate further generative models. As the candidate metrics may include encoding using trained encoder models and other computer model processing, this approach enables the selection of an effective candidate metric and exploration of potential candidate metrics that use encoders and/or scoring functions that differ from those explicitly proposed as candidate metrics.

Experiments performed with generative models for image generation revealed that one popular metric, FIS, performed relatively poorly compared to other candidate models. In addition, use of the FIS metric yielded scores for diffusion-style models that ranked these models significantly more poorly than the human evaluations. By selecting an evaluation metric as discussed herein, an improved metric can be used to evaluate models and determine their effectiveness while maintaining consistency with human evaluation. Because the selected evaluation metric may be implemented with an encoding model and evaluate model performance without human intervention, the selected metric may also enable automated evaluation with models that mimic human evaluation. This metric may then be applied to models to select a preferred generative model, such as evaluating different models, different versions or architectures of a model, different model training approaches, and so forth.

### BRIEF DESCRIPTION OF THE DRAWINGS

FIG. 1 illustrates a system for evaluating and applying metrics for generative models, according to one embodiment.

FIG. 2 shows example evaluation and selection of a candidate metric, according to one or more embodiments.

FIG. 3 illustrates an example application of the selected metric for evaluating generative models, according to one embodiment.

FIG. 4 illustrates the evaluation of one candidate metric for image generation models against human evaluation in one experiment.

FIG. 5 shows additional experimental results for various candidate metrics evaluated for different reference data sets.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture Overview

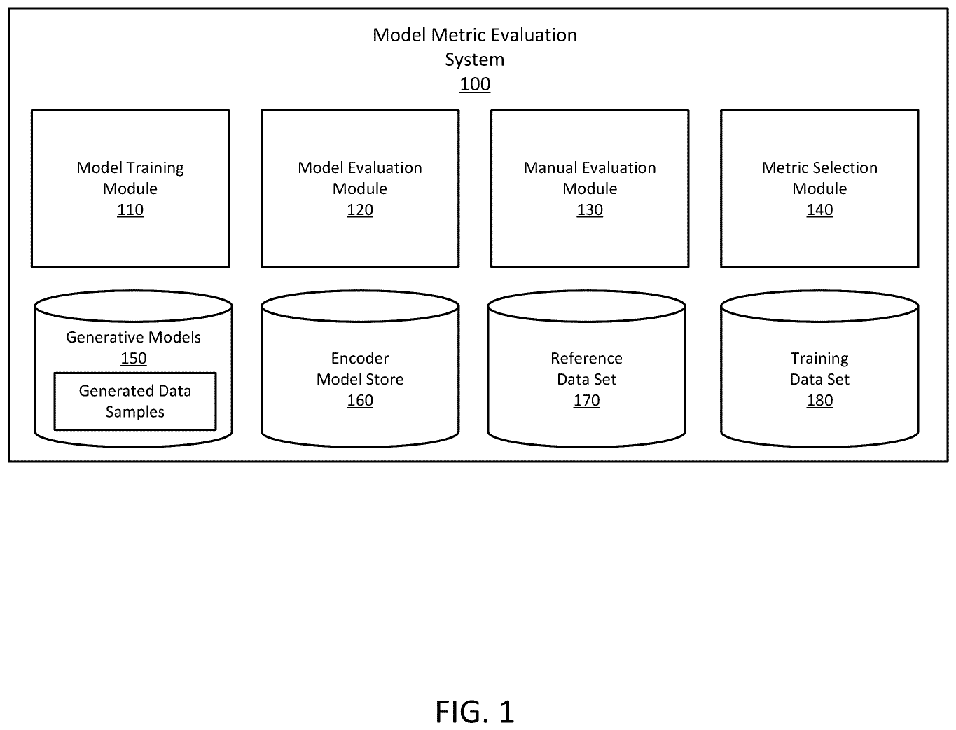

FIG. 1 illustrates a system for evaluating and applying metrics for generative models, according to one embodiment. A model metric evaluation system 100 evaluates a number of potential metrics for evaluating generative models and compares the potential metrics with human evaluations of data samples from the generative models to identify metrics that align with human evaluation of data fidelity. In general, generative models are trained on a set of real data to generate synthetic or “fake” data having a similar distribution to the data set on which the generative model was trained while also avoiding reproduction of identical copies (memorizing) of training data samples. As such, to have high fidelity with the real-world training data, generated data samples from the models should appear to be real-world data, rather than generated or simulated data samples. The model metric evaluation system 100 includes various modules and data stores for applying various metrics to a number of generative models and evaluating the metrics for selection of a metric that aligns with human notions of “real” data samples, rather than “fake” data samples.

The model metric evaluation system 100 shown in FIG. 1 includes various components that may be used to select and apply an effective metric for evaluating generative models. In various embodiments, certain components may be omitted or functions performed by alternate systems in communication with the model metric evaluation system 100. In addition, various aspects of the invention may be performed by processing units (e.g., CPUs, GPUs), that are located on various separate devices. As such, the various data stores and processing components discussed with respect to FIG. 1 may include various systems and data stores operating in conjunction with one another across various communication systems, and may include cloud or other distributed implementations. Rather, the features of the model metric evaluation system 100 are shown and discussed with respect to one device for convenience and may be differently configured in various embodiments.

The model metric evaluation system 100 includes a number of generative models 150 that may be used to generate respective data samples for evaluation. In general, the generative models 150 (and the respective samples) evaluated by the metrics may be pre-trained or pre-existing, and in some embodiments may be trained by the model metric evaluation system 100 using a model training module 110. Each generative model 150 is trained to generate data samples according to a reference data set 170. The generative models 150 include a number of computer modeling layers according to the particular architecture of the respective generative model 150 and may include convolutional layers, pooling layers, neural layers, fully connected layers, activation layers, recurrent layers, and so forth. During training by the model training module 110 the generative models 150 are trained according to a suitable training method and may include various model training methods such as gradient descent, stochastic gradient descent, and similar optimization techniques. As examples, the generative models 150 may include diffusion models, generative adversarial networks, variational autoencoders, normalizing flows, Transformer-based models, consistency models, and the like. In general, these models aim to generate “similar” data samples to the “real” data in the reference data set 170 without memorizing the reference data itself, and are generally intended to also learn a distribution, such that the types of data samples randomly generated by the generative models should be similar to the types of data samples in the reference data set 170.

The reference data set 170 includes a database of data samples of a particular type to be learned by the generative models. The reference data set varies in different embodiments and may include, for example, images, video, text, audio, and so forth. In the examples discussed herein, the various data sets and models use image data. The reference data set 170 may include publicly-available or open-source data sets and for image data may include data sets such as CIFAR10, ImageNet, Flickr-Faces-HQ (FFHQ), and Large-scale Scene Understanding (LSUN) and so forth.

After training, samples are drawn from the generative models 150 to obtain generated data samples associated with each generative model 150. The generated data samples may thus represent the output of the generative models to be evaluated and determine the quality of the respective generative models 150 based on the data set used to train the models.

A model evaluation module 120 and manual evaluation module 130 may perform evaluation of the generated data samples from the various generative models 150. The model evaluation module 120 evaluates the generative models 150 with a plurality of candidate metrics that may include applying an encoder from encoder model store 160 along with a scoring function for the metric. In general, the candidate metrics may use an encoder to generate a representation of an input data sample in a latent space according to parameters of the encoder. The scoring function may then be applied to evaluate the generated data samples in the representation space. A specific combination of a particular encoder and a particular scoring function combination is referred to as a fidelity metric that may be used to evaluate a generative model.

The encoder models may include pre-trained encoding models, such as non-generative models that may be trained for purposes other than generating new data samples. These may include, for example, supervised models, such as classifiers, in which class or type data is available for learning representations. For classification models, the layer immediately before classification outputs (e.g., classification heads) may be used as the “representation” of the data sample. In additional examples, encoders may include self-supervised models, autoencoders, and other model types that generate a compact representation/features of a data sample.

As such, the encoder models may include encoders and other representation-generating models that have been proposed for use as metrics to evaluate generative models 150 and can also include models and model types that have not been proposed for evaluation of generative models 150. That is, non-generative models that provide effective representation spaces (i.e., operating as encoders) may be used as a candidate metric to evaluate whether the representation space of the encoder is effective with a scoring function. This permits various types of encoding models to be evaluated as (and potentially repurposed as) an effective metric for generative models. In particular, this approach permits parallel examination of a variety of representation/latent spaces that may be generated with respect to a variety of encoding model types. In addition to different model architectures, encoders may also differ in the training data used to train the encoders along with the training procedure used to train them, which may yield different encoding representations for data samples. In many cases, encoder models are trained to learn a representation space for extracting effective features for characterizing data samples or learning a representation that may be used to recreate (e.g., in an autoencoder) the original data sample.

For generative models relating to images, embodiments may include various types of models used as an encoder, including supervised classification models, self-supervised feature extractors, and autoencoders, including models implementing contrastive (e.g., SimCLRv2), self-distillation (DINOv2), canonical correlation analysis (SwAV), masked image modeling (MAE and data2vec), and language-image (CLIP and OpenCLIP) approaches. For convolutional neural networks (CNN), various types of model architectures may be used, such as ResNet50. As noted above, many such models, model types, and varying training processes for them have not previously been considered for use as metrics; by generating respective latent space representations by these models for generative data samples, these models and the respective latent spaces may be evaluated for use with scoring functions as effective metrics for generative models.

After processing by an encoder, a particular candidate metric typically evaluates a scoring function within the representation space produced by the encoder. For example, such a scoring function may evaluate a distance or other measure of representations for one or more of the generated data samples relative to one or more of the data samples from the reference data set. For example, these scoring functions for generative images may include the Fréchet Distance (FD), spatial Fréchet Distance, Inception Score (IS), Kernel Inception Distance (KID), and Feature Likelihood Score (FLS). The combination of a particular encoder (i.e., the encoded representation space) and a particular scoring function yields a specific metric. For example, the Fréchet Inception Distance (FID) is a metric that uses the Inception-V3 network as an encoder (a supervised classifier without the classification heads) with a Fréchet Distance as a scoring function between encoded data sets.

In addition to the evaluation by automated fidelity metrics, the manual evaluation module 130 coordinates human evaluation to determine evaluation of the generated data samples 150 by human evaluators. The human evaluators may evaluate the generated data samples in various ways in various embodiments, and generally may determine whether generated data samples are perceived by the human evaluators to be a real data sample (a member of the reference data set 170) or a simulated data sample (a “fake” data sample generated by a generated model). The manual evaluation module 130 may obtain example reference data samples 170 and generated data samples from generative models 150 to query human evaluators. In one embodiment, the manual evaluation module 130 sequentially prompts human evaluators to evaluate a randomized mixture of reference data samples and generated data samples and receive human evaluation of whether each data sample appears real or simulated to the evaluator. In some embodiments, the human evaluator may be instructed on the proportion of data samples that belong to each group before evaluation (e.g., that 50% of the data samples to be presented are simulated/“fake” and that 50% of the data samples are reference/“real”). As such, different generative models 150 may receive a different frequency that generated samples from the model are considered “real” by the human evaluators, indicating a more realistic and thus more effective generative model 150.

A metric selection module 140 may then evaluate the performance of models as evaluated by the candidate metrics and by the human evaluators to determine preferred metrics for evaluating generative models 150. As discussed further below, the metric selection module may use similarity of evaluation by the candidate metrics relative to the human evaluation to select a metric that aligns with the human evaluation. This metric may then be used to evaluate further models as a proxy for model quality (e.g., generated data sample fidelity to real data) without further human evaluation. Such further generative models 150 may be trained by a separate training data set 180 that may differ from the reference data set 170.

### Selection and Use of Candidate Metrics

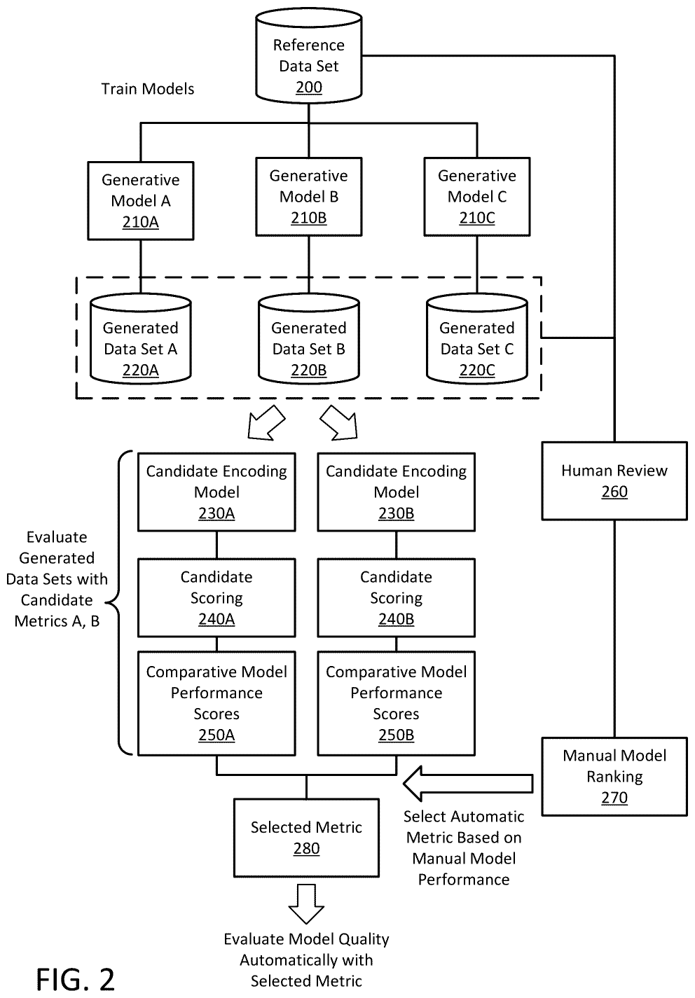

FIG. 2 shows example evaluation and selection of a candidate metric, according to one or more embodiments. The processing discussed with respect to FIG. 2 may be performed by components of the model metric evaluation system 100, including the model evaluation module 120, manual evaluation module 130, and metric selection module 140.

Initially, a plurality of generative models 210A-C are trained with a reference data set 200. The generative models 210A-C may have different parameters, architectures, and characteristics such that while the data used for learning the generative models 210A-C may be the same, the model architectures (e.g., number, type, and sequence of processing layers) and/or training processes differ for each generative model 210A-C. Each generative model 210A-C thus provides a set of generative models trained to generate data samples based on the reference data set 200 and are generally intended to learn both the regions of the data samples in an input domain, as well as the distribution of data in that domain. For example, in an image data set, the reference data set may include real-world images of 10 different types of objects in different frequencies. Each of the generative models 210A-C may then be sampled from to obtain a respective generated data set 220A-C, providing a set of generated data samples associated with each generative model as trained by reference data set 200. As with the generative models 210A-C, in some embodiments the generated data sets 220A-C may be pre-existing and may be retrieved for evaluation as discussed below.

A well-trained generative model 210 is expected to learn the “regions” of image space (e.g., pixel values across the length and width of an image) that correspond to “real” images for the 10 different object types, as well as the frequency that each object type should be generated. As such, images that appear “not real” indicate regions of the input space that may poorly correspond to the reference data set 200. To determine metrics that are effective for measuring model fidelity, a plurality of candidate metrics are compared with human evaluation of generated sample fidelity. As an overview, the evaluation of the various models 210, as measured by the respective generated data sets, is measured by the various candidate metrics to determine related comparative model performance scores 250, which can be evaluated against a manual model ranking 270.

To obtain the comparative model performance scores 250, each candidate metric is applied to the generated data set for each generative model 210A-C. Each candidate metric may be used to evaluate each of the models, such that scoring and/or ranking of the various generative models 210A-C can be determined by each of the candidate metrics. In various embodiments, each of the candidate metrics may implement different ways of evaluating the generated data sets 220. Although not shown in FIG. 2., in many instances, the candidate metrics evaluate a generated data set in view of the reference data set 200.

For many candidate metrics, the metric may be obtained by first applying a candidate encoding model 230 to obtain representation(s) of the generated data set 220 (and often, of the reference data set 200) and then applying a candidate scoring 240 the representation(s). Each of the candidate encoding models 230 may differ from one another to evaluate how different encoders and resulting representations perform for use as an evaluative metric. In the example of FIG. 2, a first candidate metric is obtained by applying a candidate encoding model 230A and scoring the resulting representation(s) with candidate scoring 240A. By applying the metric to each generated data set 220A-C, a resulting set of comparative model performance scores 250A may be generated that indicates the evaluation, according to the first candidate metric (applying encoding model 230 and candidate scoring 240A) of the generative models 210A-C. In some embodiments, the comparative model performance scores 250A (i.e., the evaluation with the candidate metric) may be a raw score output from the candidate scoring for each model 210. In other embodiments, the scoring of each model from the candidate metric may be converted to a ranking of the generated data sets or other comparative evaluation. In the example of FIG. 2., a second set of comparative performance scores 250B is generated for a second candidate metric by applying the candidate encoding model 230B to each generated data set 220A-C and applying candidate scoring 240B to the representations output by the candidate encoding model 230B.

Although shown in FIG. 2 as using separate candidate encoding models 230A-B and separate candidate scoring 240A-B, different candidate metrics may share one or more components for determining the comparative model performance scores 250 and vary in other components. Thus, the candidate encoding models may differ for different candidate metrics while the candidate scoring may be the same. As one example for evaluating images, a first candidate metric may use a supervised classifier (e.g., Inception v3) as the candidate encoding model 230 and Fréchet Distance (FD) as the candidate scoring. A second candidate metric may use a self-supervised learning model (e.g., self-distillation in DINOv2) as the candidate encoding model and also use FD for scoring. This may permit a comparison of the representations from the different encoding models when used with FD for model quality evaluation. Similarly, the same candidate encoding model 230 may be used for different candidate metrics that use different candidate scoring 240.

For comparison with the candidate model performance scores 250A-B, a human review 260 may be performed with human evaluators to determine the quality of the generated data sets 220A-C. As discussed above, the human evaluator may evaluate whether the evaluator believes a presented data sample is from the reference data set 200 (“real”) or from a sampled data set 220 (“fake”). As such, the human evaluators evaluate whether the generated images correspond to the region of image data that includes real-world images. The human evaluators 270 may thus evaluate each of the generated data sets 220A-C to generate a comparative performance of the generate models 210A-C. The human evaluations may thus describe the frequency that human evaluators evaluated data samples from each generated data set 220A-C as “real,” from the reference data set 200, or non-generated. The frequency that human evaluators estimated generated data sets 220A-C as real may then be used to rank the respective generative models 210A-C as a manual model ranking 270.

The comparative model performance scores 250A-B are then evaluated with respect to the manual model rankings 270 to determine a selected metric 280. Each of the candidate metrics, along with the human evaluation, thus generates respective evaluations of the plurality of generative models 210A-C. The candidate metric selected as the metric to be used for evaluating model fidelity may be the candidate metric that most closely aligns with the manual evaluations. As such, the manual model ranking 270 may be compared to determine a correlation, similarity, or other statistical metric with respect to the comparative model performance scores 250A-B from each of the candidate metrics. Stated another way, when the generative models are ordered by the manual model ranking 270, candidate metrics that most align with the manual model ranking 270 should also general increase (or decrease).

In some embodiments, in addition to similarity with the manual model ranking 270, the candidate metrics may also be evaluated with respect to additional metrics for different metrics of performance for the generative model performance. For example, additional metrics may measure precision, recall, memorization, model diversity, and other characteristics of the generated data set 220 for a generative model 210. Performance of the generative models with respect to metrics measuring these other characteristics may also be used to select among similarly-performing candidate metrics or to indicate that a candidate metric should not be selected as a proxy for model quality. For example, if a candidate metric appears to show increased performance for models that also increase with measures of memorization, that candidate metric may be ineffective as a measure of model quality.

Although discussed with respect to generating data sets 220A-C and manual model rankings 270, the generated data and manual review in some embodiments may be performed once. To evaluate a new candidate metric, the existing data samples and rankings may be retrieved for evaluation of the candidate metric against prior candidate metrics and the manual model ranking 270. As such, when a new encoding model or candidate scoring is available or proposed, a candidate metric may be constructed with the encoding model and scoring to evaluate the generated data sets 220A-C to generate a set of comparative model performance scores 250 for the new proposal. This also enables relatively easy evaluation of potential metrics and the identification of an effective metric from unexpected sources. As discussed below, experiments show one metric popularly used for evaluating generative image models often does not align with manual model rankings and can lead to models scoring highly on that metric which do not score highly in the manual model rankings 270. Meanwhile, this approach can evaluate and thus identify effective alternate metrics from any encoding model that can be interpreted to generate representations of data samples. As such, encoding models that may be trained for non-generative purposes (e.g., autoencoders, self-supervised learning, distillation, etc.) can be evaluated and demonstrated as an effective metric for evaluating generative models. In the experiments discussed below, a self-distillation model (“DINOv2”), not proposed for use evaluating generative models, outperformed the popular FID metric when compared to human evaluations of realism.

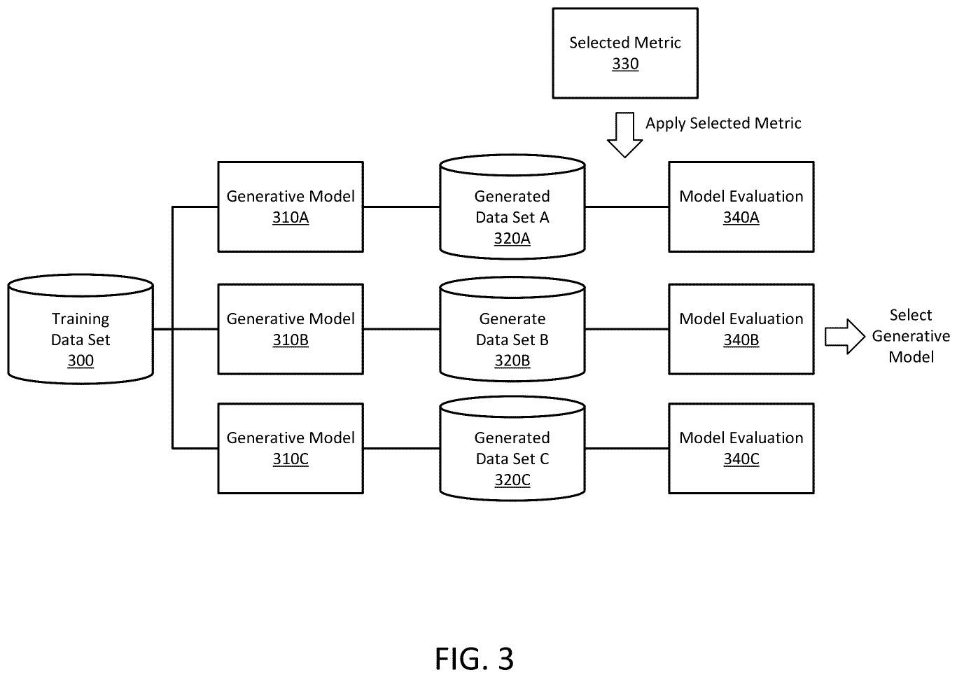

FIG. 3 illustrates an example application of the selected metric for evaluating generative models, according to one embodiment. In this example, a number of generative models 310A-C are trained on a training data set 300. In this example, the training data set 300 may differ from the reference data shown in FIG. 2 that trained the generative models that were used to evaluate the efficacy of the metrics. As such, the training data set 300 may include a private data set or a data set associated with a particular purpose or context. The generative models 310A-C may provide different architectures, training processes, and other parameters relative to one another. After training, each generative model 310A-C is sampled from to obtain respective generated data sets 320A-C. The selected metric 330 may then be applied to the generated data sets 320A-C to determine a set of model evaluations 340A-C according to the selected metric 330. Because the selected metric 330 is identified relative to other candidate metrics and alignment with human evaluations, the model evaluations 340A-C may be an effective proxy for the realism of the generated data from each generative model 310A-C. Such evaluation is otherwise difficult to effectively determine without human evaluation of generative models or best-guesses about the efficacy of particular metrics. Using the model evaluations 340A-C, the relative performance of the generative models 310A-C can be determined and used to select preferred models. The highest-performing generative model 310A-C may be selected as the generative model to be used for further purposes or may be used as the basis for further model development. When the metric for model evaluation does not effectively represent realistic data samples, worse-performing models may be selected for further development and use.

### Experimental Results

Experiments were performed to evaluate various candidate metrics for generative models of images. In these experiments, generative models trained on a number of different reference data sets were evaluated with various candidate metrics to evaluate the similarity of candidate metrics across different reference data sets. In particular, the reference data sets include CIFAR10, ImageNet, LSUN-Bedroom, and FFHQ. For each reference data set, a number of different generative models were trained (or obtained) that with various types of model architectures, including Consistency models, Diffusion models, Flow-based models, Generative Adversarial Networks (GANs), Transformers, and Variational Autoencoders (VAEs).

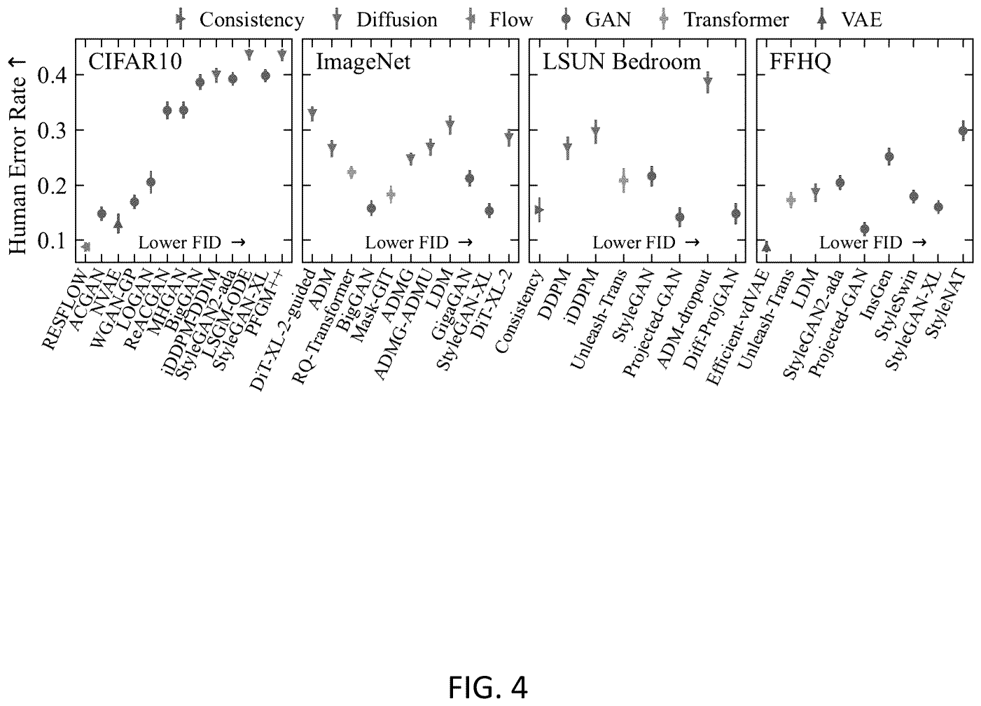

FIG. 4 illustrates the evaluation of one candidate metric for image generation models against human evaluation in one experiment. FIG. 4 shows four plots, corresponding to generative models trained on each reference data set of the experiment. One popular metric, Fréchet Inception Distance (FID), which uses an Inception encoder and Fréchet Distance for scoring, is compared with the human error rate (frequency that human evaluators incorrectly identified generated data samples as “real”). The mean human error rate is plotted along with standard error for each model, and models are sorted on the x-axis by FID. Each trained generative model architecture is labeled across the x-axis. If FID correlated well with human perception of fidelity, each plot would have a monotonically increasing trend, but this does not appear to hold. By inspection, the models with highest fidelity are almost always diffusion models, although GAN models often have lower FID. Although FID has become a popular metric and may previously be used to drive model generative development, because it does not correlate well with human-evaluated fidelity, using FID to select models and determine which model architectures to develop further may lead to development and use of models with poor fidelity to real data samples. FIG. 4 also illustrates the benefit of evaluating the candidate metric across models trained on different reference data sets. While FID is generally monotonically increasing with respect to CIFAR10, making FID appear a relatively strong candidate metric, when considered with respect to different reference data sets, particularly ImageNet and LSUN Bedroom, FID does not appear to increase with increasing human evaluations of fidelity.

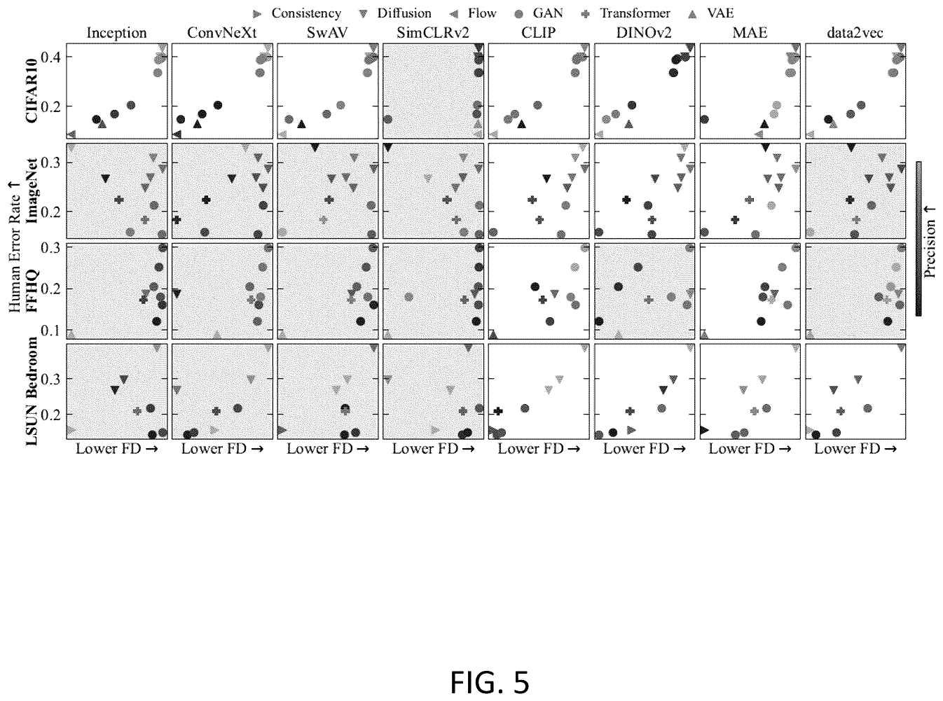

FIG. 5 shows additional experimental results for various candidate metrics evaluated for different reference data sets. In this experiment, each candidate metric uses a different encoding model and is scored using Fréchet Distance (FD). Each column includes plots for a different encoder model across the respective reference data sets, including the Inception model used with the FID (Fréchet Inception Distance) as shown in FIG. 4. As with the example in FIG. 4, each plot orders generative models along the x-axis as evaluated by the candidate metric according to decreasing FD, with the human evaluated error rate on the y-axis. As can be shown in these charts, the Inception encoder does not appear to best align with the human evaluation of generated image fidelity. Rather, encoding models, such as CLIP (Contrastive Language-Image Pre-training) and DINOv2 (a self-supervised encoder), that were not previously proposed as generative metrics, performed most effectively across various data sets in aligning with human perceptions.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system comprising:
one or more processing elements that executes instructions; and
a non-transitory computer-readable medium comprising instructions executable by the processing elements for:
identifying a set of generative models trained to generate data samples based on a reference data set;
identifying, for each generative model in the set of generative models, a generated data set generated by the generative model;
determining a plurality of model rankings for a corresponding plurality of candidate model metrics, each comparative model performance ranking describing comparative performance of the set of generative models based on the generated data set of each generative model evaluated by the corresponding candidate model metric;
identifying a manual model ranking describing comparative performance of the set of generative models based on the generated data set of each generative model evaluated by human evaluation; and
selecting an automated quality metric for evaluating model quality from the plurality of candidate model metrics based on a similarity between the manual model ranking and the plurality of model rankings.

2. The system of claim 1, wherein the instructions are further executable for:
applying the automated quality metric to evaluate a first generative model and a second generative model; and
selecting a preferred model from the first model and second model based on the evaluation with the automated quality metric.

3. The system of claim 2, wherein the first generative model and the second generative model are trained on a data set different from the reference data set.

4. The system of claim 1, wherein the similarity between the manual model ranking and the plurality of model rankings is measured by a statistical correlation.

5. The system of claim 1, wherein the instructions are further executable for:
evaluating the set of generative models according to a supplemental metric related to at least diversity or memorization;
determining whether each candidate model metric is correlated with degradation of the supplemental metric; and
wherein selecting the automated quality metric comprises selecting a candidate model metric that is not correlated with degradation of the supplemental metric.

6. The system of claim 1, wherein the human evaluation includes an experimental comparation of the generated data set and the reference data set.

7. The system of claim 1, wherein at least one metric applies an encoding model to the generated samples and applies a scoring function to encoded data samples.

8. A method performed by one or more processors, comprising:
identifying a set of generative models trained to generate data samples based on a reference data set;
identifying, for each generative model in the set of generative models, a generated data set generated by the generative model;
determining a plurality of model rankings for a corresponding plurality of candidate model metrics, each comparative model performance ranking describing comparative performance of the set of generative models based on the generated data set of each generative model evaluated by the corresponding candidate model metric;
identifying a manual model ranking describing comparative performance of the set of generative models based on the generated data set of each generative model evaluated by human evaluation; and
selecting an automated quality metric for evaluating model quality from the plurality of candidate model metrics based on a similarity between the manual model ranking and the plurality of model rankings.

9. The method of claim 8, further comprising:
applying the automated quality metric to evaluate a first generative model and a second generative model; and
selecting a preferred model from the first model and second model based on the evaluation with the automated quality metric.

10. The method of claim 9, wherein the first generative model and the second generative model are trained on a data set different from the reference data set.

11. The method of claim 8, wherein the similarity between the manual model ranking and the plurality of model rankings is measured by a statistical correlation.

12. The method of claim 8, further comprising:
evaluating the set of generative models according to a supplemental metric related to at least diversity or memorization;
determining whether each candidate model metric is correlated with degradation of the supplemental metric; and
wherein selecting the automated quality metric comprises selecting a candidate model metric that is not correlated with degradation of the supplemental metric.

13. The method of claim 8, wherein the human evaluation includes an experimental comparation of the generated data set and the reference data set.

14. The method of claim 8, wherein at least one metric applies an encoding model to the generated samples and applies a scoring function to encoded data samples.

15. A non-transitory computer-readable storage medium comprising instructions executable by a processor to:
identify a set of generative models trained to generate data samples based on a reference data set;
identify, for each generative model in the set of generative models, a generated data set generated by the generative model;
determine a plurality of model rankings for a corresponding plurality of candidate model metrics, each comparative model performance ranking describing comparative performance of the set of generative models based on the generated data set of each generative model evaluated by the corresponding candidate model metric;
identify a manual model ranking describing comparative performance of the set of generative models based on the generated data set of each generative model evaluated by human evaluation; and
select an automated quality metric for evaluating model quality from the plurality of candidate model metrics based on a similarity between the manual model ranking and the plurality of model rankings.

16. The non-transitory computer-readable storage medium of claim 15, wherein the instructions further cause the processor to:
apply the automated quality metric to evaluate a first generative model and a second generative model; and
select a preferred model from the first model and second model based on the evaluation with the automated quality metric.

17. The non-transitory computer-readable storage medium of claim 16, wherein the first generative model and the second generative model are trained on a data set different from the reference data set.

18. The non-transitory computer-readable storage medium of claim 15, wherein the similarity between the manual model ranking and the plurality of model rankings is measured by a statistical correlation.

19. The non-transitory computer-readable storage medium of claim 15, wherein the instructions further cause the processor to:
evaluate the set of generative models according to a supplemental metric related to at least diversity or memorization;
determine whether each candidate model metric is correlated with degradation of the supplemental metric; and
wherein selecting the automated quality metric further causes the processor to select a candidate model metric that is not correlated with degradation of the supplemental metric.

20. The non-transitory computer-readable storage medium of claim 15, wherein the human evaluation includes an experimental comparation of the generated data set and the reference data set.
